(19) United States
(12) Patent Application Publication
(10) Pub. No.: US 2008/0098934 A1
(43) Pub. Date: May 1, 2008

(54) Cement Mortar Composition and Concrete Composition

(76) Inventors: Sang-woon Kwak, Seoul (KR); Ji-young Kwak, Kyunggi-Do (KR)

Correspondence Address: CANTOR COLBURN, LLP, 20 Church Street, 22nd Floor, Hartford, CT, 06103, US

(21) Appl. No.: 11/597,256

(22) PCT Filed: May 18, 2005
(86) PCT No.: PCT/KR05/01455

§ 371 Date: Sep. 7, 2007

(30) Foreign Application Priority Data
May 19, 2004 (KR) 10-2004-0035627

(51) Int. Cl. C04B 14/42; C04B 14/22

(52) U.S. Cl. 106/711; 106/814

(57) ABSTRACT

The present invention provides a cement mortar composition and concrete composition and particularly, it provides a cement mortar composition comprising 100 parts by weight of cements, 100 to 300 parts by weight of glass beads, and 50 to 200 parts by weight of blending water and a concrete composition comprising the cement composition and aggregates. The cement mortar composition and concrete composition of the invention have excellent fluidity with the use of a small amount of blending water so that they can promptly migrate in the direction of gravity in a mold complicated with steel rods and other wires, prevent material separation and remove bubbles present inner or outer areas due to superior filling performance, can remarkably improve waterproof property of mortar (or concrete) and prevent their degradation. Besides, they require no additional cooling systems which are installed to control heat of hydration in civil engineering such as dams, piers and tunnels that are largely cast by absorbing the generated hydration heat within the mortar (or concrete), show no material separation phenomena, can block the alteration of a structure generated by corrosion by converting the surface of reinforcing rods into passevation, and enable high quality by having a reduced construction period due to shortened time to gain initial hardness from the start of construction, and having the high smoothness of finished faces and having no unevenness such as bubbles due to excellent filling performance.

### TECHNICAL FIELD

The present invention relates to a cement mortar composition and concrete composition and more particularly, it relates to a cement mortar composition and concrete composition showing excellent fluidity, waterproof and degradation properties with the use of a small amount of blending water, being capable of preventing material separation and removing bubbles present inner or outer areas due to superior filling performance, requiring no additional systems to remove hydration heat, showing no material separation phenomena by excellent compatibility with steel products by lowering the surface tension of the mortar (or concrete), being able to block the alteration of a structure generated by corrosion, and having the high smoothness of finished faces, and a method for the construction of a structure using the same.

### BACKGROUND ART

Cement mortar compositions and concrete compositions have been mostly used for new construction, repair, or reinforcement of concrete structures and civil engineering, and recently, their application to the gravel layers of rails in the construction of railroads has been studied.

In the construction of railroads, rails are mounted on crossties made of woods or concretes and the bottom of the crossties are filled with gravels to support and hold the crossties and to tie them so that they are not deviated from predetermined positions. However, as the gravels do not bind one another and may freely scatter, they can drift away from the railroads by weather conditions such as snows and rains or external force. In such case, gravels are to be refilled, or scattered gravels cause damages on trains by spattering to the wheels of the trains when the trains pass and incur a huge loss.

Accordingly, in order to reduce such problems, in developed countries, they are attempting to construct cement mortar compositions within such gravel layers so that the gravels can be curdled one another. However, prior cement mortar compositions merely stick surface gravels together due to their low penetration ability and they do not tie the deep bottom area of the gravel layers. Thus, with regard to the bottom layer gravels, the aforementioned problem that the gravels are readily drifted away remains unsolved. In addition, in case of the construction of the railroads, as construction section is wide and construction is carried out on railroads which are being driven, it is advisable to construct as much as possible at a time and then to be opened for traffic again. However, as the prior cement mortar compositions generate a lot of hydration heat during the construction, thereby making large construction impossible, the construction period was lengthened when the entire railroads are to be constructed.

### DISCLOSURE OF INVENTION

### Technical Problem

In order to solve the above-mentioned problems, it is an object of the present invention to provide a cement mortar composition and concrete composition showing excellent fluidity with the use of a small amount of blending water so that they can promptly migrate in the direction of gravity within a complicated mold due to steel rods and other wires, being capable of preventing material separation and removing bubbles present inner or outer areas due to superior filling performance by penetrating the voids between the aggregates and having excellent adhesion after construction and drying process, and a method for the construction of a structure using the same.

It is another object of the invention to provide a cement mortar composition and concrete composition capable of remarkably improving waterproof property of mortar (or concrete) and preventing their degradation by reducing capillaries and gaps which are the migration routes of water by use of small amount of blending water, thereby preventing the absorption, diffusion and flow of water into mortar structures, and a method for the construction of a structure using the same.

It is still another object of the invention to provide a cement mortar composition and concrete composition requiring no additional cooling systems which are installed to control the heat of hydration in civil engineering such as dams, piers and tunnels that are largely cast by absorbing the generated hydration heat within the mortar (or concrete), showing no material separation phenomena by excellent compatibility with steel products by lowering the surface tension of the mortar (or concrete), and being able to block the alteration of a structure generated by corrosion by converting the surface of reinforcing rods into passevation, and a method for the construction of a structure using the same.

Further, it is another object of the invention to provide a cement mortar composition and concrete composition enabling high quality construction due to continuous construction and enabling high quality by having a reduced construction period due to the shortened time to gain initial hardness from the start of construction, and having the high smoothness of finished faces and having no unevenness such as bubbles due to excellent filling performance, and a method for the construction of a structure using the same.

Further, it is another object of the invention to provide a cost-effective cement mortar composition and concrete composition with excellent properties such as hardness, tensile strength, impact resistance, crack resistance, etc., and a method for the construction of a structure using the same.

### Technical Solution

To achieve the aforementioned objects, the present invention provides a cement mortar composition comprising:

a) 100 parts by weight of a cement;

b) 100 to 300 parts by weight of a glass bead; and

c) 50 to 200 parts by weight of a blending water.

Further, the invention provides a concrete composition comprising the cement mortar composition and d) an aggregate.

Further, the invention provides a method for the construction of a structure using a cement mortar composition or concrete composition, characterized in that the above cement mortar composition or the concrete composition is applied.

### Advantageous Effects

The cement mortar composition and concrete composition of the invention have excellent fluidity with the use of a small amount of blending water so that they can promptly migrate in the direction of gravity in a mold complicated with steel rods and other wires, they can prevent material separation and remove bubbles present inner or outer areas due to superior filling performance by penetrating the voids between the aggregates, they have excellent adhesion after construction and drying process, they can remarkably improve waterproof property of mortar (or concrete) and prevent their degradation by reducing capillaries and gaps which are the migration routes of water by use of small amount of blending water thereby preventing the absorption, diffusion and flow of water into the mortar structure, and they show superior properties in hardness, tensile strength, impact resistance, crack resistance, etc. In addition, there is no need of additional cooling systems which are installed to control heat of hydration in civil engineering such as dams, piers and tunnels that are largely cast because the generated hydration heat is absorbed within the mortar (or concrete), there are no material separation phenomena because of excellent compatibility with steel products by the low surface tension of the mortar (or concrete), the alteration of a structure generated by corrosion can be blocked by the conversion of the surface of reinforcing rods into passevation, high quality construction can be achieved by continuous construction and high quality is possible because the construction period is reduced due to the shortened time to gain initial hardness from the start of construction, and due to excellent filling performance, the smoothness of finished faces is high and there is no unevenness such as bubbles.

The invention has been described and illustrated in detail with reference to preferred embodiment but it is not limited by the detailed description or preferred embodiment. It will be understood by those skilled in this art that other and further changes and modifications may be made without departing from the spirit and scope of the invention which is defined by the claims appended hereto.

### Mode for the Invention

The present invention is further described in detail.

The cement mortar composition of the invention is characterized in that it comprises 100 parts by weight of a cement, 100 to 300 parts by weight of a glass bead, and 50 to 200 parts by weight of a blending water.

For the cement of a) in the invention, there can be used any ordinary cements that are used in the pertinent art.

For example, the cement includes blending cements such as ordinary Portland cements, white cements, blast furnace cements, silica cements and fly ash cements, alumina cements, colloidal cements, oil well cements, geothermal cements, acid-resistant cements and so on and they can be picked and employed according to the specific purpose. Particularly, Portland cements are preferable in consideration of construction cost and availability.

The glass bead of b) in the invention has a role in increasing penetration by providing very excellent fluidity by its ball bearing effect so that the composition of the invention can reach narrow gaps and deep places and it also provides excellent dispersion into other mixtures. Further, it helps cements and dry mixtures show excellent storage ability so that they can be mixed well by simple stirring even after long-term storage and it has high strength and hardness and thus provides excellent hardness and impact resistance against the hardened cement mortar compositions. Also, the glass bead enables large construction by absorbing the hydration heat generated during the hardening process by virtue of its high specific heat, and it enables precise construction by reducing the shrinkage rate of the hardened objects after construction by the use of a small amount of blending water as compared with the prior cement mortar compositions.

Those having various particle sizes can be employed as the glass bead and they can be obtained by treatment of glass powders obtainable by milling glass, cullet, glass fiber, or glass cutlet wherein the glass components are not limited to specific ones as long as they are compatible to cements and they include A, C, E, alkali resistance glass powder components, etc.

For the glass beads, sphere, oval, or any other corresponding shapes can be used and also, there can be used all kinds of from those where various sizes are distributed to those having only a selected certain size.

The diameter of the glass beads can be suitably chosen and used according to the objects to be constructed and preferably, those having 1 [symbol] to 3 [symbol] can be employed. Further, it is possible to exhibit various morphology and properties by combination of beads having small diameters of several [symbol] and beads having large diameters of several [symbol] . However, if the diameter exceeds 3 [symbol] , they show low dispersion ability and they cannot be efficiently used. In particular, it is preferable to use the glass beads of large diameters in a relatively large amount when mortars or concrete are used in large quantity and to use the beads of small diameters in a large amount when a small amount of cement mortars are used.

Preferably, the glass bead is contained in an amount of 100 to 300 parts by weight of 100 parts by weight of the cement. When the amount is within the above ranges, it is advantageous in that the cement mortar composition has excellent strength and hardness and it does not fall off after the hardening process.

For the blending water of c) in the invention, ordinary water can be used and preferably, it is contained in an amount of 50 to 200 parts by weight of 100 parts by weight of the cement so as to maintain a suitable viscosity for construction.

Also, the cement mortar composition of the invention may further comprise a glass powder in addition to the above-illustrated components.

The glass powder improves cohesion and at the same time it increases adhesion by controlling the surface tension of the cement mortar, thereby increasing the hardness of the hardened cement mortar composition, it enlarges impact resistance and tension strength by increasing the viscosity of the cement mortar, and it inhibits shrinkage and expansion.

Glass powders having various particle shapes and sizes can be employed as the glass powder, and the particles of the glass powder are those obtainable by milling glass, cullet, glass fiber, or glass cullet wherein the glass components are not limited to specific ones as long as they are compatible to the cement and they include A, C, E, alkali resistance glass powder components, etc. Particularly, the glass powder of E-glass components is advisable in aspect of adhesion.

The diameter of the glass powder is not specially limited, but it is preferably 10 [symbol] to 1 [symbol] , more preferably 5 [symbol] to 1 [symbol] . When the diameter of the glass powder is too small or too big, the strength of the hardened cement mortar or concrete may be reduced, or shrinkage and expansion may increase.

As the glass powder does not absorb water, it can be used in a large amount within the cement mortar composition of the invention, and even in case that the content of the glass powder is high, it mixes and disperses well within the cement and it has excellent volume filling effects.

Preferably, the glass powder is contained in an amount of 10 to 500 parts by weight of 100 parts by weight of the cement and when the amount is within the above ranges, it has good shrinkage-expansion characteristics and good adhesion ability.

Further, the cement mortar composition of the invention may further comprise a glass fiber.

The glass fiber has a role in increasing the tension strength and crack resistance of the hardened object through the function as a fibrous composite inside the hardened object when the cement mortar composition is hardened.

For the glass fiber, E-component long glass fiber or alkali resistance component fiber can be used and in particular, there can be used a chopped fiber which is made by chopping a glass fiber or carbon fiber having a fiber diameter of 10 to 20 [symbol] into uniform strand length or a milled fiber which is made by milling it into an average fiber length. Especially, it is preferred that the chopped fiber is cut to have a fiber length of 2 to 12 mm in consideration of fibrous effects, the convenience of construction and the fluidity and penetration of the mortar composition and the milled fiber has an average fiber length of 100 to 300 [symbol] in consideration of the normal fiber diameter of milled fibers, the convenience of preparation and fibrous effects. Particularly, the milled fiber is advantageous in consideration of the easiness of preparation, costs, the reinforcement of tension strength and dispersion and there can be also used a mixture of the chopped fiber and the milled fiber.

Preferably, the glass fiber is contained in an amount of 5 to 100 parts by weight of 100 parts by weight of the cement, and when the amount is within the above ranges, the hardened object has excellent tensile strength and cracks, shrinkage and expansion do not occur.

Further, the cement mortar composition of the invention may further comprise a re-dispersible powder resin in addition to the above-mentioned components.

The re-dispersible powder resin is a dried, sprayed synthetic resin emulsion and it refers to the powder of a resin that can be re-dispersed when water is applied thereto.

Generally, the re-dispersible powder resin, which is an acrylic, vinyl acetate and vinyl chloride synthetic resin, prevents the evaporation of water, improves waterproof characteristics, increases the bending strength of a member and prevents cracks occurring by the shrinkage of cement by forming an irreversible polymer film that does not dissolve in water after dry or hardening. Also, it increases adhesion to organic or inorganic basement by combination with pigments or filling agents by functioning as a binder during the dry or hardening process, thereby increasing the compression strength, adhesion strength, wear resistance and flexibility of the hardened object.

In particular, as the re-dispersible powder resin, there can be used styrene-acryl copolymer, vinyl acetate monopolymer, vinyl acetate/ethylene copolymer, vinyl acetate/vinyl versatate copolymer, vinyl acetate/vinyl versatate/vinyl laurate terpolymer, ethylene/vinyl laurate/vinyl chloride terpolymer synthetic resins or mixtures thereof according to its application field and preferably, Swiss Elotex 50 series, more preferably 50V/920 can be used.

Preferably, the re-dispersible powder resin is contained in an amount of 1 to 50 parts by weight of 100 parts by weight of the cement, and when the amount is within the above ranges, adhesion strength, hardness, strength and other properties of a hardened object are excellent.

Besides, the cement mortar composition of the invention may further use other additives that are usually added to cement mortar compositions, such as a coagulant, hardener, hardening accelerator, hardening retardant, expansion agent, etc.

Further, the present invention provides a concrete composition comprising the cement mortar composition comprising the above-mentioned components and d) an aggregate. As the aggregate, there can be used sands, gravels, etc. that are usually used in the pertinent art, and the mixing, thickness, content of the aggregates (sands or gravels) can be adjusted according to the use of the concrete composition of the invention.

The cement mortar composition and concrete composition comprising the afore-mentioned components have excellent fluidity with the use of a small amount of blending water so that they can promptly migrate in the direction of gravity in a mold complicated with steel rods and other wires, they can prevent material separation and remove bubbles present inner or outer areas due to superior filling performance by penetrating the voids between the aggregates, they have excellent adhesion after construction and drying process, they can remarkably improve waterproof property of mortar (or concrete) and prevent their degradation by reducing capillaries and gaps which are the migration routes of water by use of small amount of blending water thereby preventing the absorption, diffusion and flow of water into the mortar structure, and they show superior properties in hardness, tensile strength, impact resistance, crack resistance, etc.

Further, the invention provides a method for the construction of a structure using a cement mortar composition or concrete composition, characterized in that the cement mortar composition or the concrete composition is applied wherein the construction of the structure refers to not only the construction, repair and reinforcement of a normal construct or structure but also the construction, repair and reinforcement of a construct or structure in wet and aqueous environments.

Particularly, the construction of the structure encompasses the new construction, repair and reinforcement of constructs or structures such as a house, school, building, apartment, etc.; civil engineering where cement is consumed in a large quantity for example, the new construction, repair and reinforcement of roads, railroads, etc.; the new construction, repair and reinforcement of dams, piers, tunnels, etc.; and the construction, repair and reinforcement of all kinds of constructs or structures to which cement mortar compositions or concrete composition are applied.

Especially, for the new construction of the constructs or structures, the concrete composition of the invention can be employed and for the repair and reinforcement, the cement mortar composition can be employed.

The method for the construction of the structure is carried out by the same methods in various construction fields to which prior cement mortars or concretes are applied, and where large quantity of cement mortar is to be constructed within a short time as seen in gravel fixation on railroads, dam construction, pier construction, etc., or the excellent penetration of cement mortar compositions or concrete compositions is required, its effect is remarkable.

According to the invention, there is no need of additional cooling systems which are installed to control the heat of hydration in civil engineering such as dams, piers and tunnels that are largely cast because the generated hydration heat is absorbed within the mortar (or concrete), there are no material separation phenomena because of excellent compatibility with steel products by the low surface tension of the mortar (or concrete), the alteration of a structure generated by corrosion can be blocked by the conversion of the surface of reinforcing rods into passevation, high quality construction can be achieved by continuous construction and high quality is possible because the construction period is reduced due to the shortened time to gain initial hardness from the start of construction, and due to excellent filling performance, the smoothness of finished faces is high and there is no unevenness such as bubbles.

For better understanding of the present invention, preferred embodiments follow. The following examples are intended to illustrate the invention more fully without limiting the scope of the invention.

### EXAMPLE 1

A cement mortar composition was prepared by evenly mixing a mixture of 1 kg of cement and 2 kg of a glass bead having an average diameter of 0.1 mm and 1.0 L of a blending water.

### EXAMPLE 2

A cement mortar composition was prepared in accordance with the same method as Example 1, with the exception that 500 g of a glass powder having an average diameter of 200 meshes and a specific gravity of 2.54 was additionally added to Example 1.

### EXAMPLE 3

A cement mortar composition was prepared in accordance with the same method as Example 1, with the exception that 100 g of a milled glass fiber having an average fiber thickness of 13.5 [symbol] and an average fiber length of 300 [symbol] was additionally added to Example 1.

### EXAMPLE 4

A cement mortar composition was prepared in accordance with the same method as Example 1, with the exception that 200 g of a glass powder having an average diameter of 200 meshes and a specific gravity of 2.54 and 100 g of a milled glass fiber having an average fiber thickness of 13.5 [symbol] and an average fiber length of 300 [symbol] were additionally added to Example 1.

### EXAMPLE 5

A cement mortar composition was prepared in accordance with the same method as Example 1, with the exception that 50 g of Elotex 50V/920 as a re-dispersible powder resin was additionally added to Example 1.

### EXAMPLE 6

A concrete composition was prepared by evenly mixing a mixture of 1 kg of concrete and 2 kg of a glass bead having an average diameter of 0.1 mm and 2.5 L of a blending water.

### EXAMPLE 7

A concrete composition was prepared in accordance with the same method as Example 6, with the exception that 200 g of a glass powder having an average diameter of 200 meshes and a specific gravity of 2.54 was additionally added to Example 6.

### EXAMPLE 8

A concrete composition was prepared in accordance with the same method as Example 6, with the exception that 100 g of a milled glass fiber having an average fiber thickness of 13.5 [symbol] and an average fiber length of 300 [symbol] was additionally added to Example 6.

### EXAMPLE 9

A concrete composition was prepared in accordance with the same method as Example 6, with the exception that 200 g of a glass powder having an average diameter of 200 meshes and a specific gravity of 2.54 and 100 g of a milled glass fiber having an average fiber thickness of 13.5 [symbol] and an average fiber length of 300 [symbol] were additionally added to Example 6.

### EXAMPLE 10

A concrete composition was prepared in accordance with the same method as Example 6, with the exception that 50 g of Elotex 50V/920 as a re-dispersible powder resin was additionally added to Example 6.

### COMPARATIVE EXAMPLE 1

A cement mortar composition was prepared by evenly mixing a mixture of 1 kg of cement, 50 g of Elotex 50V/920 as a re-dispersible powder resin and 2 kg of sand for cement mortar and 3 L of a blending water.

### COMPARATIVE EXAMPLE 2

A concrete composition was prepared by evenly mixing a mixture of 1 kg of concrete, 50 g of Elotex 50V/920 as a re-dispersible powder resin and 2 kg of sand for cement mortar and 3 L of a blending water.

With regard to the cement mortar compositions and concrete compositions prepared in Examples 1 to 10 and Comparative Examples 1 and 2, adhesion strength, compression strength, tensile strength, bending strength, hardness, length change rate, hydration heat, penetration, setting time, stability, absorption rate, chemical resistance, freezing and thawing resistance, neutralization resistance, etc. were measured through the following experimental procedures. As a result, the cement mortar compositions of Examples 1 to 5 prepared by the present invention showed excellent performances in all of the above-mentioned characteristics as compared with the composition of Comparative Example 1 and the concrete compositions of Examples 6 to 10 showed excellent performances in all of the above-mentioned characteristics as compared with Comparative Example 2.

(1) Adhesion Strength Test

After base concrete specimen (60 60 10 [symbol] ) were prepared using a concrete having a compression strength of about 500 [symbol] , they were coated with the cement mortars in a thickness of 5 mm. After 28 days, 3 attachments having a size of 4 4 [symbol] were attached for adhesion strength test. The test was carried out in accordance with adhesion tests KS F 4715 (wall coatings for thin texture finishes), JIS A 6909 (finishing coating materials for laminates), and JIS A 6910 (finishing coating materials for multi-layers). The adhesion strength of at least 7 [symbol] is required at 28 days for mortars for repair.

(2) Compression Strength Test

5 cm-cubic specimen were fabricated using the cement mortars and after 1 day, they are released. After atmospheric curing, compression strength was measured at 3, 7 and 28 days according to KS F 5105.

(3) Chemical Resistance Test

According to ASTMC 267-92, the above-prepared compositions were immersed in 3% aqueous solution of magnesium sulfate for 72 hours for acid resistance test and were immersed in 5% aqueous solution of calcium chloride for 72 hours for base res istance test, and then their appearance were observed.

### INDUSTRIAL APPLICABILITY

The cement mortar composition and concrete composition of the invention have excellent fluidity with the use of a small amount of blending water so that they can promptly migrate in the direction of gravity in a mold complicated with steel rods and other wires, they can prevent material separation and remove bubbles present inner or outer areas due to superior filling performance by penetrating the voids between the aggregates, they have excellent adhesion after construction and drying process, they can remarkably improve waterproof property of mortar (or concrete) and prevent their degradation by reducing capillaries and gaps which are the migration routes of water by use of small amount of blending water thereby preventing the absorption, diffusion and flow of water into the mortar structure, and they show superior properties in hardness, tensile strength, impact resistance, crack resistance, etc. In addition, there is no need of additional cooling systems which are installed to control heat of hydration in civil engineering such as dams, piers and tunnels that are largely cast because the generated hydration heat is absorbed within the mortar (or concrete), there are no material separation phenomena because of excellent compatibility with steel products by the low surface tension of the mortar (or concrete), the alteration of a structure generated by corrosion can be blocked by the conversion of the surface of reinforcing rods into passevation, high quality construction can be achieved by continuous construction and high quality is possible because the construction period is reduced due to the shortened time to gain initial hardness from the start of construction, and due to excellent filling performance, the smoothness of finished faces is high and there is no unevenness such as bubbles.

The invention has been described and illustrated in detail with reference to preferred embodiment but it is not limited by the detailed description or preferred embodiment. It will be understood by those skilled in this art that other and further changes and modifications may be made without departing from the spirit and scope of the invention which is defined by the claims appended hereto.

1. A cement mortar composition comprising:
a) 100 parts by weight of a cement;
b) 100 to 300 parts by weight of a glass bead; and
c) 50 to 200 parts by weight of a blending water.

2. The cement mortar composition according to claim 1 wherein the glass bead of b) has a diameter of 1 [symbol] to 3 [symbol] .

3. The cement mortar composition according to claim 1 further comprising a glass powder having a diameter of 10 [symbol] to 1 [symbol] in an amount of 10 to 500 parts by weight of 100 parts by weight of the cement.

4. The cement mortar composition according to claim 1 further comprising a chopped fiber which is made by chopping a glass fiber or carbon fiber having a fiber diameter of 10 to 20 [symbol] into uniform strand length or a milled fiber which is made by milling it into average fiber length of 100 to 300 [symbol] in an amount of 5 to 20 parts by weight of 100 parts by weight of the cement.

5. The cement mortar composition according to claim 1 further comprising at least one re-dispersible powder resin selected from the group consisting of styrene-acryl copolymer, vinyl acetate monopolymer, vinyl acetate/ethylene copolymer, vinyl acetate/vinyl versatate copolymer, vinyl acetate/vinyl versatate/vinyl laurate terpolymer and ethylene/vinyl laurate/vinyl chloride terpolymer synthetic resins in an amount of 1 to 50 parts by weight of 100 parts by weight of the cement.

6. The cement mortar composition according to claim 1 further comprising a coagulant, hardener, hardening accelerator, hardening retardant or expansion agent.

7. A concrete composition comprising the cement mortar composition set forth in claim 1 and d) an aggregate.

8. A method for the construction of a structure using a cement mortar composition or concrete composition, characterized in that the cement mortar composition set forth in claim 1 or the concrete composition set forth in claim 7 is applied.

9. The method according to claim 8 wherein the construction of the structure is operated for the new construction, repair and reinforcement of a house, school, building, apartment, road, railroad, dam, pier, or tunnel.

10. The method according to claim 8 wherein the construction of the structure is operated for the fixation of a gravel layer in the construction of a railroad containing the gravel layer.

11. The method according to claim 8 wherein the construction of the structure is to build a dam.

12. The method according to claim 8 wherein the construction of the structure is to build a pier.
